(19) United States
(12) Patent Application Publication
(10) Pub. No.: US 2026/0343189 A1
(43) Pub. Date: Oct. 29, 2026

(54) BEACON DEVICE FOR INDOOR POSITIONING SYSTEM

(71) Applicant: BO PI, SAN DIEGO, CA (US)

(72) Inventors: BO PI, SAN DIEGO, CA (US); IRENE PI, SAN DIEGO, CA (US)

(21) Appl. No.: 19/190,032

(22) Filed: Apr. 25, 2025

(51) Int. Cl. H04W 4/33; G06F 1/16; H04W 64/00

(52) U.S. Cl. CPC H04W 4/33; G06F 1/1629; G06F 1/163; H04W 64/00

(57) ABSTRACT

A beacon device for an indoor positioning system is provided in the present application. The beacon device includes a main body having a wireless module for being communicated with gateway devices in the indoor positioning system to determine a position of the beacon device, and a magnetic buckle assembly for attaching the beacon device to a wearable object of a user; the magnetic buckle assembly includes a fixing socket arranged in the main body, and a pin member for penetrating though the wearable object and being clasped in the fixing socket, the pin member is detachable from the fixing socket by using a magnet device. An indoor positioning system using the beacon device is also provided in the present application.

### TECHNICAL FIELD

This present application generally relates to indoor positioning technology, and more particularly, to a beacon device for an indoor positioning system, which is capable of being attached to a wearable object such as clothes or other fabrics.

### BACKGROUND

In recent years, various spatial positioning technologies are developing rapidly, the current main positioning systems include Global Positioning System (GPS), Global Navigation Satellite System (GLONASS), and Compass Navigation Satellite System (CNSS or BeiDou). These positioning systems mainly use satellite signals for positioning and have advantages of wide-range coverage, large-scale user access, and good outdoor positioning accuracy. However, when these systems are used for indoor positioning, due to influence of building shielding, strength of the satellite signals may suffer greatly attenuating, which further seriously affects the indoor positioning accuracy.

In view of the above problem of the satellite positioning systems, some indoor positioning technologies are developed by using short-distance indoor wireless communication, such as UWB (ultra-wide band), WLAN (wireless local area network), or Bluetooth connection. The WLAN-based positioning technology has advantage of low deployment cost and simple algorithm, but it is susceptible to signal interference; the UWB-based positioning technology has a higher precision for indoor positioning, but it needs to consume more power and also has high cost. Compared to the above-mentioned two indoor positioning technologies, Bluetooth-based technology is more suitable for high-precision indoor positioning due to its low power consumption, good transmission distance and signal stability; in addition, the Bluetooth beacon device has a smaller size and is easy to be integrated into a portable device. Therefore, Bluetooth-based technology is more applicable to indoor environments such as hospitals, nursing homes, kindergartens, shopping malls or warehouses for indoor positioning and navigation.

A typical Bluetooth indoor positioning system includes a beacon device which is wirelessly connected to gateway devices via Bluetooth channels, the gateway devices may be communicated with the beacon device to receive Bluetooth ranging signals from the beacon device, which can further be used for detecting a position of the beacon device. When the beacon device is carried by a user, the user's location can then be determined correspondingly. However, since the beacon device is small and portable, it is liable to be lost or be forgotten to bring by the user; under this condition, the indoor positioning system is incapable of detecting the user's actual location in real time. This may raise serious troubles when the user is an old patient or a young child who needs to be taken good care of.

It is, therefore, desired to provide a beacon device a beacon device for an indoor positioning system, which can overcome the above-mentioned problem.

### SUMMARY

The examples of implementations described in the present application provide a beacon device for an indoor positioning system, which can be attached to a wearable object of a user to protect the beacon device from being lost or forgotten to bring by the user.

In an implementation according to one aspect of the present application, a beacon device for an indoor positioning system is provided. The beacon device includes a main body having a wireless module for being communicated with gateway devices in the indoor positioning system to determine a position of the beacon device, and a magnetic buckle assembly for attaching the beacon device to a wearable object of a user; the magnetic buckle assembly includes a fixing socket arranged in the main body, and a pin member for penetrating though the wearable object and being clasped in the fixing socket, the pin member is detachable from the fixing socket by using a magnet device.

In an implementation according to another aspect of the present application, an indoor positioning system is also provided. The indoor positioning system includes a plurality of gateway devices, and at least one beacon device being wirelessly communicated with the gateway devices; each of the at least one beacon device includes a main body having a wireless module for being communicated with the gateway devices to determine a position of the beacon device, and a magnetic buckle assembly for attaching the beacon device to a wearable object of a user; the magnetic buckle assembly includes a fixing socket arranged in the main body, and a pin member for penetrating though the wearable object and being clasped in the fixing socket; the pin member is detachable from the fixing socket by using a magnet device.

The above and other aspects and features are described in greater detail in the following detailed description taken in conjunction with the accompanying drawings and claims.

### BRIEF DESCRIPTION OF THE DRAWINGS

For a more complete understanding of this disclosure. reference is now made to the following brief description, taken in connection with the accompanying drawings and detailed description, wherein like reference numerals represent like parts.

FIG. 1 is a schematic diagram of an indoor positioning system with a plurality of beacon devices according to an exemplary embodiment of the present application.

FIG. 2 is an isometric diagram of an exemplary beacon device for the indoor position system of FIG. 1, taken from a main front view.

FIG. 3 is another isometric diagram of the beacon device of FIG. 2, taken from a rear view.

FIG. 4 is a side view of the beacon device of FIG. 2.

FIG. 5 is an exploded diagram of the beacon device of FIG. 2, illustrating a magnetic buckle assembly thereof for being attaching to a wearable object.

FIG. 6 is a perspective diagram of the magnetic buckle assembly of FIG. 5.

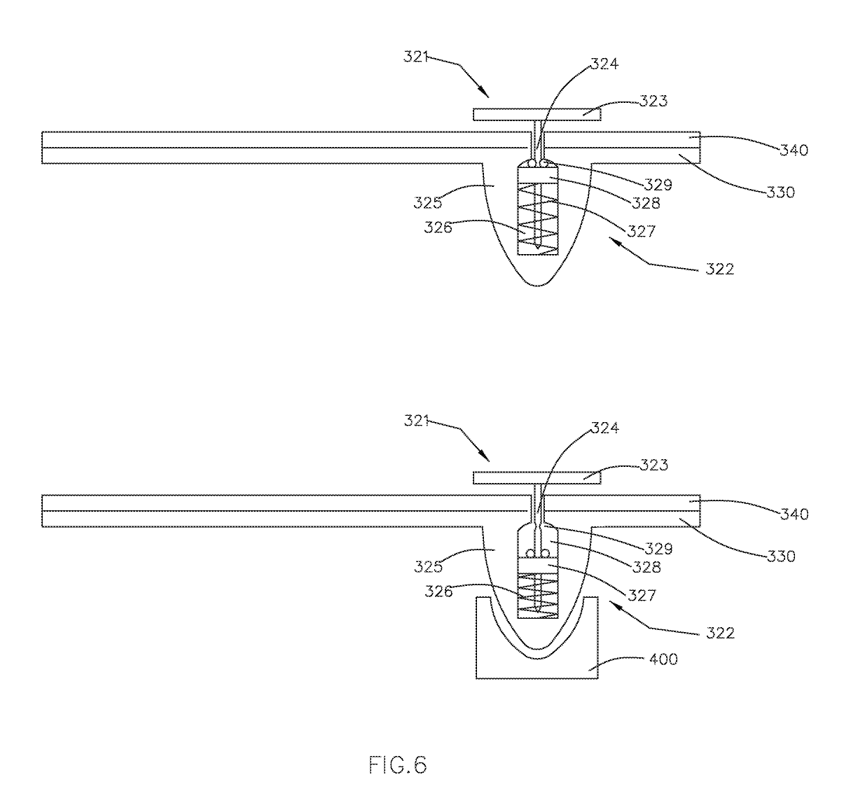

### DETAILED DESCRIPTION

Detail technical solutions in various embodiments of the present application will be described hereinafter in conjunction with the attached drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following description is directed to a number of various embodiments. The described embodiments, however, may be implemented and/or varied in many different ways. For example, the described embodiments may be implemented as a beacon device which is applicable to an indoor positioning system, the beacon device includes a buckle module (such as a magnetic buckle assembly) for enabling a main body of the beacon device to be attached to a target object, the target object may typically be a wearable object such as clothes or other fabrics. When the beacon device is attached to the wearable object, the beacon device can be protected from being lost or forgotten to bring by the user, and therefore can improve a positioning reliability and performance of the indoor positioning system.

As an exemplary embodiment, the indoor positioning system may be a Bluetooth-based positioning system; in this system, the beacon device is wirelessly communicated with other network devices in the indoor positioning system via Bluetooth channels, such as Bluetooth low energy (BLE) channels that is defined in Bluetooth core specification by Bluetooth Special Interest Group (SIG). For example. the Bluetooth SIG releases a new version of core specification recently (which is known as Bluetooth version 6.0) that defines a new Bluetooth channel sounding solution using a phase-based ranging (PBR) technology. The PBR technology takes advantage of signal phase and its relationship with frequency to achieve high-precision ranging between Bluetooth devices; and moreover, if necessary, the PBR technology can also be combined with a round-trip timing (RTT) technology to improve a ranging accuracy. Therefore, in the Bluetooth-based indoor positioning system, the beacon device can reveal its exact location to the network devices within a considerable distance, to obtain a ranging accuracy in decimeter-level or even centimeter-level.

In other embodiments, however, the beacon device can alternatively be other wireless beacon device such as UWB or WLAN beacon device, which is communicated with the network devices of the indoor positioning system by using other wireless connection channels such as UWB channels or WLAN channels.

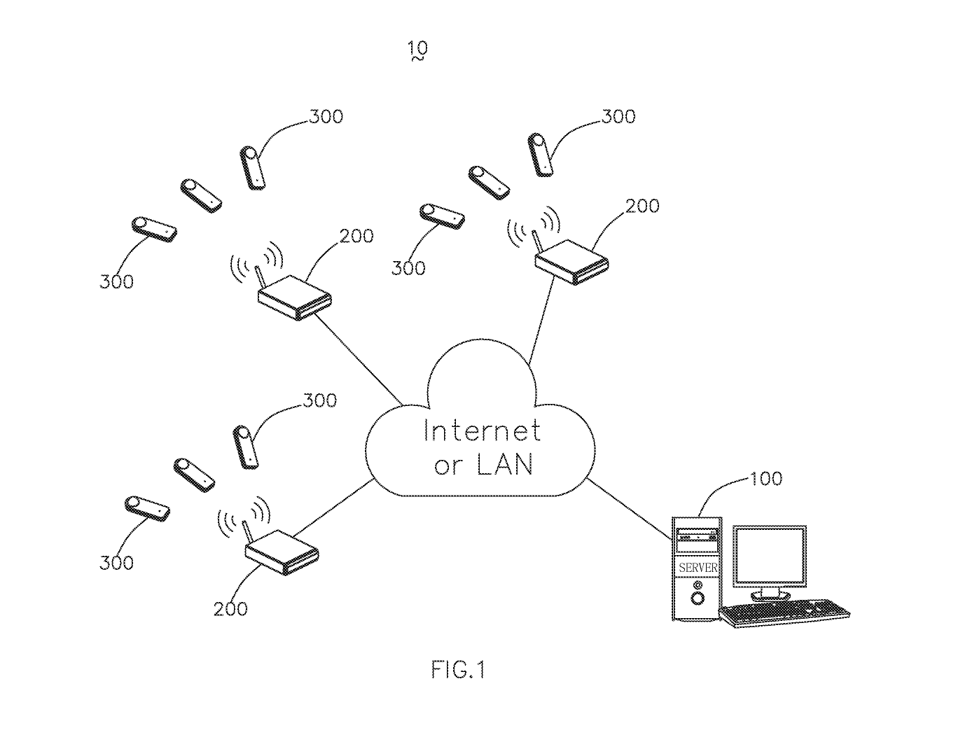

Referring to FIG. 1, a schematic diagram of an indoor positioning system according to an exemplary embodiment of the present application is shown. The indoor positioning system 10 may be deployed in a building having or more levels, and be configured for indoor positioning and navigation within the building. The building may for example be one of a hospital, a nursing home, a kindergarten, a shopping mall, a warehouse, and the like. The indoor positioning system 10 includes a server 100, a plurality of gateway devices 200, and a plurality of beacon devices 300.

The server 100 may be configured as a central device for the indoor positioning system 100, and is connected to the gateway devices 200 via a network (e.g. Internet or a local area network). The gateway devices 200 are distributed in the building where the indoor positioning system 100 is deployed, and may be accessed to the network for communicating with the server 100. The plurality of beacon devices 300 are configured as portable devices which may be brought by a user (for example, be attached to a wearable object of the user), and can be wirelessly connected to the neighboring gateway devices 200 according to an actual location of the user.

The gateway devices 200 may be Bluetooth gateway devices, and each of the beacon device 300 may be a Bluetooth beacon for communicating with the corresponding gateway devices 200 via Bluetooth channels. In an exemplary embodiment, three or more gateway devices 200 is distributed in each level of the building, for example, the three or more gateway devices 200 may be disposed on a room ceiling, a hall, a corridor, or the like. When the beacon device 300 is brought to a certain location of the building based on a movement of the user, the beacon device 300 may be detected by the gateway devices 200 in a vicinity of the user, and then the beacon device 300 can be wirelessly connected to the corresponding gateway devices 200 by use of Bluetooth channels.

For example, the beacon device 300 may transmit beacon messages to the neighboring gateway devices 200, the beacon message typically includes an identity of the beacon device 300, and may optionally include other operation information such as remaining battery information, temperature information, etc. As an exemplary embodiment, the beacon message may be transmitted in accordance with a low-power and short-range communication standard such as Bluetooth version 6.0, and can then be received by the gateway devices 200 in a vicinity of the beacon device 300. During reception of the beacon message, each of the gateway devices 200 may perform Bluetooth channel sounding to measure a distance between the beacon device 300 and the gateway device 200 based on the above-mentioned phase-based ranging (PBR) and round-trip timing (RTT) technology. Thereinafter, the gateway devices 200 can send the relevant information to the server 100, to enable the server 100 to determine a location information of the beacon device 300 accordingly. This location information of the beacon device 300 may further be used for positioning or navigation application.

As can be seen from the above description, when the beacon device 300 is taken with by the user, a real-time location of a user can be detected by the indoor position system 10. This can facilitate the service of the hospital, the nursing home, the kindergarten, and the like. Moreover, in the present application, in order to protect the beacon device 300 from being lost or forgotten to bring by the user, a magnetic buckle assembly that is designed to be attached or fixed to a wearable object of the user, is provided in the beacon device 300.

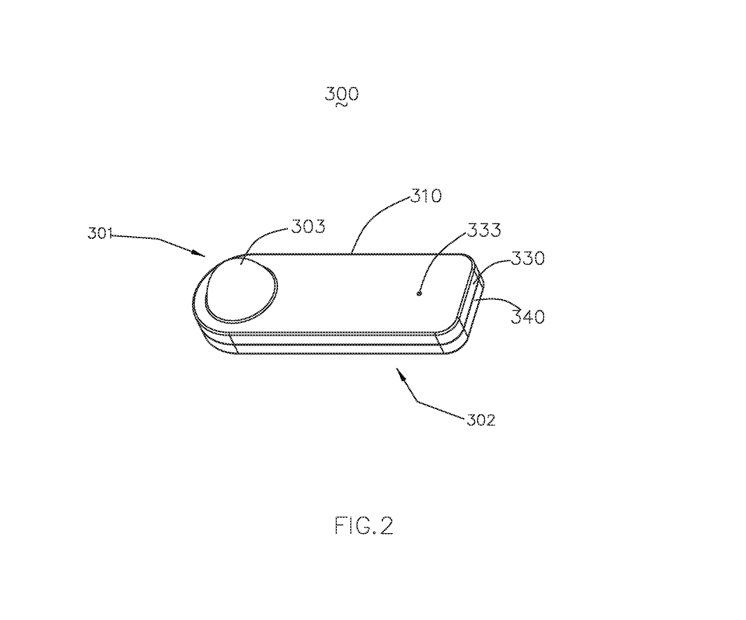

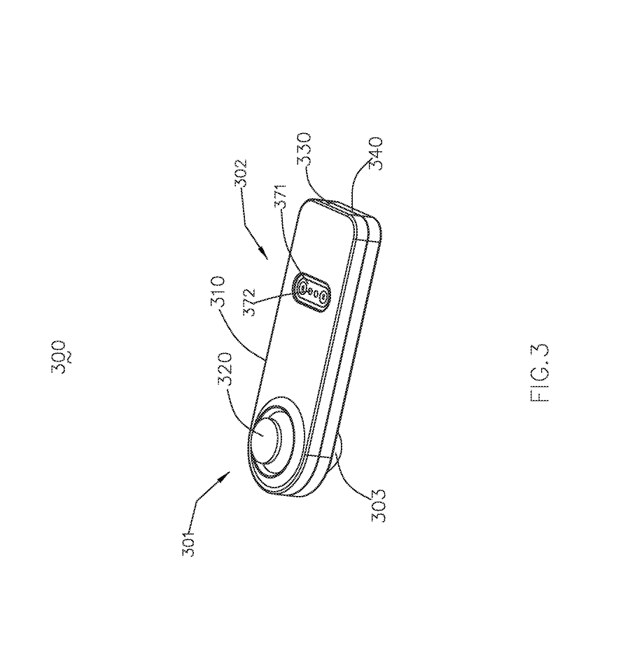

Referring to FIGS. 2-4 , a beacon device 300 according to an exemplary embodiment of the present application is shown, the beacon device 300 appliable to the indoor positioning system 10 in FIG. 1. For example, the beacon device 300 includes a main body 310 and a magnetic buckle assembly 320. The main body 310 may have a fixing head 301 and a free part 302; the magnetic buckle assembly 320 is arranged at the fixing head 301 of the main body 310. The fixing head 301 may be designed as a round fixing head with a bulging portion 303 for arrangement of the magnetic buckle assembly 320; the free part 302 is connected to the fixing head 301, which may be designed as a rectangular free part. For example, the fixing head 301 and the free part 302 may be integrated into a one-piece structure, in which the round fixing head 301 extends from one end of the rectangular free part 302.

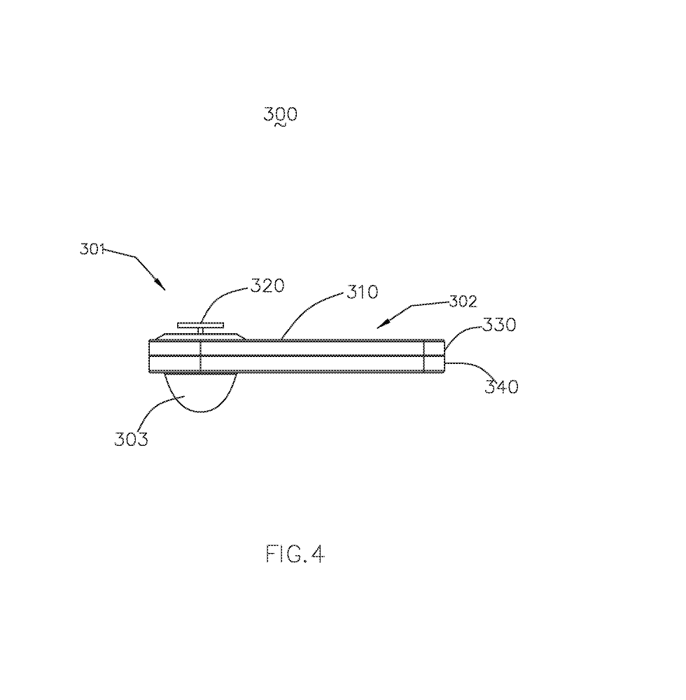

Referring also to FIG. 4, specifically, the main body 310 includes a front cover 330, a back case 340, a battery 350 and a printed circuit board assembly (PCBA) 360. The front cover 330 may be fitted to the back case 340 to form an accommodating space therebetween, the battery 350 and the PCBA 360 are received and fixed in the accommodating space, and be located in the free part 302 of the main body 310. The magnetic buckle assembly 320 is arranged at the fixing head 301, and includes a pin member 321 and a fixing socket 322. The fixing socket 322 is also received in the accommodating space formed by the back case 340 and the front cover 330, and more specifically, the fixing socket 322 is a fixing member that can be arranged within and fixed to the bulging portion 303 at the fixing head 301. The pin member 321 may be a free member that is detachably engaged with the fixing socket 312, and can penetrate through the back case 340 and be clasped in the fixing socket 322.

For example, the back case 340 includes a round recess 341 disposed at the fixing head 301, and a pinhole 342 is formed at a central bottom of the round recess 341. The detachable pin member 321 include a round pin cap 323 and a pin body 324, the pin body 324 may be extended from a central of the pin cap 323, and includes a cusp tip formed in a distal end of the pin body 324. In assembly, the pin body 324 can penetrate through a wearable object (such as the user’s clothes or other fabrics) by using the cusp tip, pass through the pin hole 342 in the recess 341 of the back case 340 and reach the fixing socket 322, and then be clasped by a clasping mechanism within the fixing socket 322 . In this manner, the wearable object is clipped between the pin cap 321 and the back case 340 by the pin body 324, and the pin cap 323 is located over the round recess 341. Moreover, the fixing socket 322 may have a semi-oval shape with a sufficient depth for receiving the pin body 324; the bulging portion 303 may be a hollow structure which protrudes from a surface of the front cover 330 at the fixing head 301, which have a configuration substantially fit for the fixing socket 322. With this configuration, the fixing socket 322 can be accommodated in the hollow bulging portion 303, and when the pin member 321 penetrating through the user’s wearable object is clasped in the fixing socket 322, the beacon device 300 can be attached to the user’s wearable object correspondingly.

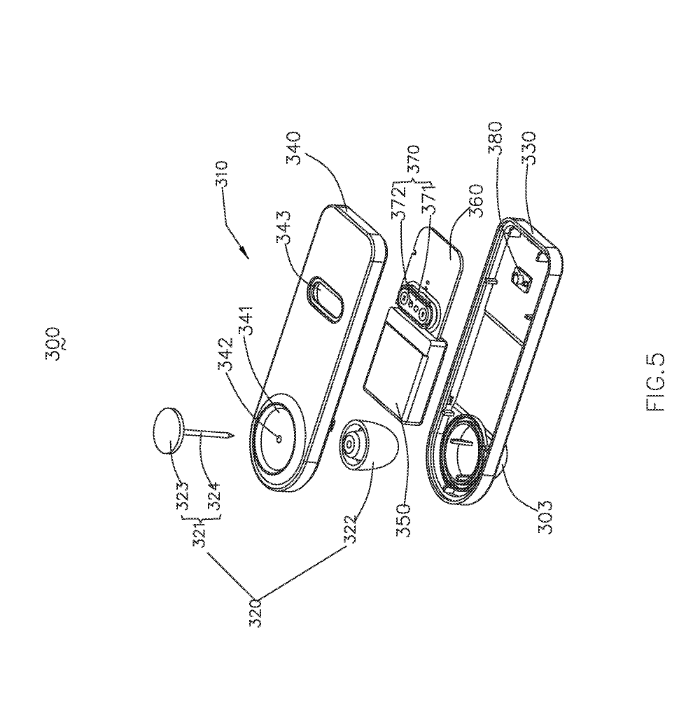

For ease of understanding, a brief introduction to a working mechanism of the magnetic buckle assembly 320 is described as follow in accompany with FIG. 5. Referring also to FIG. 5, as an example, the pin member 321 may have an annular groove formed on the pin body 324; the fixing socket 322 may include a socket body 325 with a cavity 326, an elastic member 327, a metal block 328 and a pair of movable balls 329. The elastic member 327, the metal block 328 and the pair of movable balls 329 are all arranged within the cavity 326. The fixing socket may further have an inlet formed at a top of the cavity 326, from which the pin body 323 can enter the cavity 326 in assembly. The elastic member 327 may for example be a spring, which includes a first end connected to a bottom of the cavity 326, and a second end connected to the metal block 328. The metal block 328 is located between the elastic member 327 and the movable balls 329, and is configured for supporting the movable balls 329 to the top of the cavity 326. The movable balls 329 may for example be steel balls, which are arrange adjacent to the inlet of the socket body 325.

When the magnetic buckle assembly 320 works in a normal operation state, the elastic member 327 is in an original state, which provides an elastic force to push the metal block 328 to move towards the inlet of the socket body 325, and thus the movable balls 329 are limited at and contact against the top of the cavity 326. If the beacon device 300 is desired to be attached to the user’s wearable object such as clothes or other fabrics, the magnetic buckle assembly 320 can be used. In detail, the pin body 324 of the pin member 321 can firstly penetrate through the wearable object, and then be plugged into the cavity 326 of the socket body 325 through the pinhole 342 in the back case 340; after the pin body 324 passing through the metal block 328 in the cavity 326, the movable balls 329 will slide into the annular groove on the pin body 324, this causes the pin member 321 to be clasped or locked into the fixing socket 322. As such, the beacon device 300 can be attached to the wearable object of the user, and thus can be ensured to be brought by the user.

When the beacon device 300 needs to be removed from the wearable object of the user, the pin member 321 can be detached from the fixing socket 322. Upon this condition, for example, a permanent magnet 400 may be provided and taken to the bulging portion 303 of the front cover 330; under a magnetic attraction force generated by the permanent magnet 400, the metal block 328 and the movable balls 329 are attracted to move towards the bottom of the cavity 326, which causes the elastic member 327 to be compressed and the movable balls 329 escape from the annular groove of the pin body 324. Therefore, the pin member 321 is released or unlocked and can be removed from the fixing socket 322, and the beacon device 300 can be detached from the wearable object of the user accordingly. After the permanent magnet 400 is taken away, the elastic member 327 will recover to the original state, which further causes the metal block 328 and the movable balls 329 to be pushed to the top of the cavity 326.

As can be seen, in the present embodiment, the magnetic buckle assembly 320 has a simple structure and is convenient for use to attach the beacon device 300 to the user’s wearable object, and the detachment of the beacon device 300 is also easy by using a permanent magnet 400. Therefore, the beacon device 300 as provided in the present embodiment can be protected from being lost or forgotten to bring by the user; this can improve a positioning reliability and performance of the indoor positioning system 10, and thus facilitate the service of the hospital, the nursing home, the kindergarten, and the like, in which the indoor positioning system 10 is adopted.

Referring back to FIG. 4, the battery 350 may for example be a chargeable battery, such as an ion battery; the beacon device 300 may further include a charging module 370 and an indicator light 380. The battery 350, the charging module 370 and the indicator light 380 may be mounted on and electrically connected to the PCBA 360. The charging module 370 includes a charging interface 371 for being connected to a power supply, and is configured to receive a power current from the power supply to charge the battery 350. In the present embodiment, the charging interface 371 may be a magnetic interface with a plurality of charging pins 372, which can be magnetically attached and connected to a charging connector. Moreover, to expose the charging interface 371 to the charging connector, the back case 340 may include an opening 343 formed in a region corresponding to the charging module 370, the opening 343 can be provided with a waterproof design to improve a reliability of the beacon device 300.

In the present embodiment, the charging module 370 can be mounted on a lower surface of the PCBA 360, and the indicator light 380 can be connected to an upper surface of the PCBA 360. In addition, the front cover 330 can further includes an indicator window 333, which is arranged at the free part 302. The indicator light 380 be arranged at the front cover 330 and aligned to the indicator window 333, and is configured for indicating a working status of the beacon device 300.

Furthermore, the PCBA 360 may typically include a wireless communication module, such as a Bluetooth module, the wireless communication module is configured or being communicated with the gateway devices 120 in the indoor positioning system 10, to perform the above-described channel sounding for ranging or determining a location of the beacon device 300, so as to implement the positioning and navigation function of the indoor positioning system 10.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A beacon device for an indoor positioning system, comprising:
a main body comprising a wireless module for being communicated with gateway devices in the indoor positioning system to determine a position of the beacon device, and
a magnetic buckle assembly for attaching the beacon device to a wearable object of a user, the magnetic buckle assembly comprising:
a fixing socket arranged in the main body; and
a pin member for penetrating though the wearable object and being clasped in the fixing socket, wherein the pin member is detachable from the fixing socket by using a magnet device.

2. The beacon device of claim 1, wherein the main body comprises a front cover, a back case, and a printed circuit board assembly (PCBA), the front cover is fitted to the back case to form an accommodating space for receiving the PCBA, and the wireless module is mounted on and electrically connected to the PCBA.

3. The beacon device of claim 2, wherein the wireless module is a Bluetooth module that is configured for communicating with the gateway devices via Bluetooth channels.

4. The beacon device of claim 3, wherein the wireless module is communicated with the gateway devices to determine a position of the beacon device by using Bluetooth channel sounding including at least one of a phase-based ranging (PBR) and a round-trip timing (RTT) technology.

5. The beacon device of claim 2, wherein the main body have a fixing head, and the back case comprises a recess with a through hole formed at the fixing head, the pin member comprises a pin cap and a pin body extending from a central of the pin cap; wherein when the pin member is assembled to the fixing socket, the pin body penetrate the wearable object of the user, passes through the back case via through hole, and is clasped in the fixing socket; wherein the pin cap is located over the recess of the back case after assembly.

6. The beacon device of claim 5, wherein the front cover comprises a hollow bulging portion protruding at the fixing head and having a profile substantially fit to the fixing socket; the fixing socket is received in the hollow bulging portion, and has a cavity aligned with the through hole and for receiving and clasping the pin body.

7. The beacon device of claim 6, wherein the fixing socket further comprises an elastic member, a metal block and a plurality of movable balls arranged in the cavity, an end of the elastic member is connected to a bottom of the cavity, and the other end of the elastic member is connected to the metal block; the metal block is located between the elastic member and the movable ball; wherein when the elastic member is in an original state, the metal block is supported by the elastic member to force the moveable ball to contact against a top of the cavity.

8. The beacon device of claim 7, wherein the pin body comprises an annular groove; when the pin member is assembled to the fixing socket, the pin body enters the cavity via an inlet formed at the top of the cavity, and the moveable balls in the cavity move into the annular groove to enable the pin member to be clasped or locked in the cavity.

9. The beacon device of claim 8, wherein when the pin member is detached from the fixing socket, the magnet device is provided to the bulging portion of the fixing head for providing a magnetic attractive force to the fixing socket, wherein the metal block and the movable balls are attracted to the magnet device to make the movable ball to escape from the annular groove, so that the pin member ls unlocked and is removable from the fixing socket.

10. The beacon device of claim 2, wherein the main body further comprises a chargeable battery and a charging module electrically connected to the PCBA, the back case comprises an opening corresponding to the charging module, wherein the charging module comprises a charging interface exposed from the opening for being connected to a charging connector.

11. The beacon device of claim 10, wherein the charging interface includes a plurality of charging pins, and the charging connector is a magnetic connector for being magnetically attached and electrically connected between the charging pins and a power supply.

12. The beacon device of claim 11, wherein the main body further comprises an indicator light electrically connected to the PCBA and for indicating a working status of the beacon device, wherein the front cover comprises an indicator window formed at the free part, and the indicator light is arranged at the front cover and aligned with the indicator window.

13. An indoor positioning system, comprising:
a plurality of gateway devices; and
at least one beacon device being wirelessly communicated with the gateway devices, wherein each of the at least one beacon device comprises:
a main body comprising a wireless module for being communicated with the gateway devices to determine a position of the beacon device, and
a magnetic buckle assembly for attaching the beacon device to a wearable object of a user;
wherein the magnetic buckle assembly comprises a fixing socket arranged in the main body, and a pin member for penetrating though the wearable object and being clasped in the fixing socket; the pin member is detachable from the fixing socket by using a magnet device.

14. The indoor positioning system of claim 13, wherein the gateway devices are Bluetooth gateway devices, and the wireless module of the beacon device is a Bluetooth module that is configured for communicating with the Bluetooth gateway devices via Bluetooth channels; wherein the Bluetooth module is communicated with the Bluetooth gateway devices to determine a position of the beacon device by using Bluetooth channel sounding.

15. The indoor positioning system of claim 13, wherein the main body comprises a front cover, a back case, and a printed circuit board assembly (PCBA), the front cover is fitted to the back case to form an accommodating space for receiving the PCBA, and the wireless module is mounted on and electrically connected to the PCBA; the back case comprises a recess with a through hole, the pin member comprises a pin cap and a pin body extending from a central of the pin cap; wherein when the pin member is assembled to the fixing socket, the pin body penetrate the wearable object of the user, passes through the back case via through hole, and is clasped in the fixing socket; wherein the pin cap is located over the recess of the back case after assembly.

16. The indoor positioning system of claim 15, wherein the front cover comprises a hollow bulging portion having a profile substantially fit to the fixing socket; the fixing socket is received in the hollow bulging portion, and has a cavity aligned with the through hole and for receiving and clasping the pin body.

17. The indoor positioning system of claim 16, wherein the fixing socket further comprises an elastic member, a metal block and a plurality of movable balls arranged in the cavity, an end of the elastic member is connected to a bottom of the cavity, and the other end of the elastic member is connected to the metal block; the metal block is located between the elastic member and the movable ball; wherein when the elastic member is in an original state, the metal block is supported by the elastic member to force the moveable ball to contact against a top of the cavity.

18. The indoor positioning system of claim 17, wherein the pin body comprises an annular groove; when the pin member is assembled to the fixing socket, the pin body enters the cavity via an inlet formed at the top of the cavity, and the moveable balls in the cavity move into the annular groove to enable the pin member to be clasped or locked in the cavity.

19. The indoor positioning system of claim 18, wherein when the pin member is detached from the fixing socket, the magnet device is provided to the bulging portion of the fixing head for providing a magnetic attractive force to the fixing socket, wherein the metal block and the movable balls are attracted to the magnet device to make the movable ball to escape from the annular groove, so that the pin member ls unlocked and is removable from the fixing socket.

20. A beacon device for an indoor positioning system, comprising:
a main body comprising a wireless module for being communicated with gateway devices in the indoor positioning system to determine a position of the beacon device, and
a buckle assembly for fixing the beacon device to a target object, the buckle assembly comprising:
a fixing member arranged in the main body; and
a free member detachably engaged with the fixing part, wherein the free part is configured for enabling the main body to be fixed to the target object when being engaged with the fixing part.
